(19) United States
(12) Patent Application Publication
(10) Pub. No.: US 2018/0109980 A1
(43) Pub. Date: Apr. 19, 2018

(54) METHOD OF HANDOVER, COMMUNICATION SYSTEM AND COMMUNICATION DEVICE

(71) Applicant: FUJITSU LIMITED, Kawasaki-shi (JP)

(72) Inventor: Takeshi Ohtani, Kawasaki (JP)

(73) Assignee: FUJITSU LIMITED, Kawasaki-shi (JP)

(21) Appl. No.: 15/717,251

(22) Filed: Sep. 27, 2017

(30) Foreign Application Priority Data
Oct. 19, 2016 (JP) 2016-205030

(51) Int. Cl. H04W 36/00; H04W 36/34; H04B 1/713

(52) U.S. Cl. CPC H04W 36/0027; H04W 36/34; H04W 16/14; H04W 36/0083; H04W 36/0055; H04B 1/713

(57) ABSTRACT

A method of handover includes executing a first communication between a first communication device and a terminal device using a first plurality of channels, acquiring connection information indicating the first communication and first channel information indicating a first plurality of channels, specifying, based on the first channel information and second channel information indicating a second plurality of channels to be used by a second communication device, a third plurality of channels included in both of the first plurality of channels and the second plurality of channels, switching the first communication with the terminal device from using the first plurality of channels to using the third plurality of channels based on the third channel information, and executing, based on the connection information, a handover process from the first communication to a second communication which is executed between the second communication device and the terminal device using the third plurality of channels.

### CROSS-REFERENCE TO RELATED APPLICATION

This application is based upon and claims the benefit of priority of the prior Japanese Patent Application No. 2016-205030, filed on Oct. 19, 2016, the entire contents of which are incorporated herein by reference.

### FIELD

The embodiments discussed herein are related to a method of handover, a communication system and a communication device.

### BACKGROUND

In recent years, the Internet of Things (IoT) has been widely used. In the IoT, data to be used for services is collected using devices and sensors (hereinafter referred to as IoT devices) connected to networks including the Internet. The results of processing the data on the services may be fed back to the devices.

At a location where it is difficult to install a power supply line, an IoT device that is driven by a battery is installed. In this case, as a communication method of the IoT device, low-power-consumption Near Field Communication (for example, Bluetooth (registered trademark) Low Energy (BLE)) is used in some cases.

Distances that radio waves from IoT devices that use BLE reach are very short, and communication (IP communication) using the Internet Protocol (IP) is not executed. Thus, a device that is referred to as “gateway (GW)” hosts (or is connected via a network to) an IoT device and relays data between the IoT device and a network (such as the Internet). Related-art documents are Japanese Laid-open Patent Publication No. 2016-42645 and International Publication Pamphlet No. WO2012/114937.

### SUMMARY

According to an aspect of the invention, a method of handover from a first communication device to a second communication device, the method includes executing, by the first communication device, first communication with a terminal device using a first plurality of channels, acquiring, by the second communication device, from the first communication device, connection information indicating the first communication and first channel information indicating the first plurality of channels, specifying, by the second communication device, based on the first channel information indicating the first plurality of channels and second channel information indicating a second plurality of channels to be used by the second communication device, a third plurality of channels included in both of the first plurality of channels and the second plurality of channels, transmitting, by the second communication device, to the first communication device, third channel information indicating the third plurality of channels, switching, by the first communication device, the first communication with the terminal device from using the first plurality of channels to using the third plurality of channels based on the third channel information, and executing, by the second communication device, based on the connection information acquired in the acquiring, a handover process from the first communication to a second communication which is executed between the second communication device and the terminal device using the third plurality of channels, wherein a number of channels included in the third plurality of channels is less than one or more of a number of channels included in the first plurality of channels and a number of channels included in the second plurality of channels.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a configuration according to a first embodiment;

FIG. 2 is a flowchart indicating an example of operations (handover process) according to the first embodiment;

FIG. 3 illustrates an example of a data structure of a GW management table according to the first embodiment;

FIG. 4 illustrates a state in which a current GW communicates with an IoT device;

FIG. 5 illustrates a state in which channels to be used by the current GW and an alternative GW are limited;

FIG. 6 illustrates an example of a hardware configuration of a work terminal;

FIG. 7 illustrates an example of hardware configurations of the GWs and the IoT device;

FIG. 8 illustrates an example of a configuration of a communication system according to a second embodiment;

FIG. 9 is a flowchart indicating an example of operations according to the second embodiment;

FIG. 10 illustrates an example of a data structure of a GW management table according to the second embodiment;

FIG. 11 illustrates an example of a configuration of a communication system according to a third embodiment;

FIG. 12 is a flowchart indicating an example of operations according to the third embodiment;

FIG. 13 illustrates an example of a configuration of a communication system according to a fourth embodiment; and

FIG. 14 is a flowchart indicating an example of operations according to the fourth embodiment.

### DESCRIPTION OF EMBODIMENTS

After the start of an operation of a GW, the operation of the GW may be stopped for a maintenance task. The maintenance task for the GW is, for example, the replacement of the GW, the replacement or update of software (any or a combination of an operating system (OS), middleware, an application, and the like) installed in the GW, the installation of a driver for the addition of a new device, or the like.

When the GW is stopped, communication (data collection) with an IoT device connected to the GW is stopped, and as a result, the quality of an IoT service may be reduced. To avoid the reduction in the quality, it is considered that an alternative GW with which the GW to be maintained is to be replaced is prepared or that another GW located in the vicinity of the GW to be maintained hosts the IoT device.

To connect an IoT device that executes BLE communication to a GW, tasks that are referred to as “Passkey Entry”, “Numeric Comparison” and “Out-of-band” are performed for pairing of the IoT device and the GW, for example. “Passkey Entry” is a task of inputting, in the GW, a number displayed in the IoT device. “Numeric Comparison” is a task of checking whether the number displayed in the IoT device matches a number displayed in the GW. “Out-of-band” is a task of reading information to be used for a connection to the IoT device.

However, if the number of IoT devices hosted by the GW to be maintained is large, it takes time and effort to perform the aforementioned tasks, and a worker may erroneously perform a task. To avoid an error of the tasks, the tasks may be carefully performed and a time period for performing the tasks may increase.

Hereinafter, embodiments of a communication control method, a communication device, a communication system, and a program are described with reference to the accompanying drawings. Configurations described in the embodiments are an example, and the present disclosure is not limited to the configurations described in the embodiments.

### First Embodiment

A first embodiment describes a communication system that uses a work terminal to change a destination for hosting an IoT device that executes BLE communication. A worker uses the work terminal to change a GW that is the destination for hosting the IoT device. The BLE communication has the following characteristics.

First, the communication is executed using Frequency Hopping Spread Spectrum (FHSS). FHSS is a communication method of dividing a wide frequency band into some channels, switching the frequency of a carrier wave in a short time period, and spreading signals in the wide frequency band. In the BLE communication, 40 channels are set for each 2 MHz in a wide frequency band (2402 MHz to 2480 MHz) of 2.4 GHz, and channel switching is executed 400 times per second.

Secondly, the BLE communication uses Adaptive Frequency Hopping (AFH). In AFH, a master (GW) and a slave (device) negotiate channels to be used so that a channel causing a packet loss is not used. AFH avoids the use (interference) of a channel already used by another device.

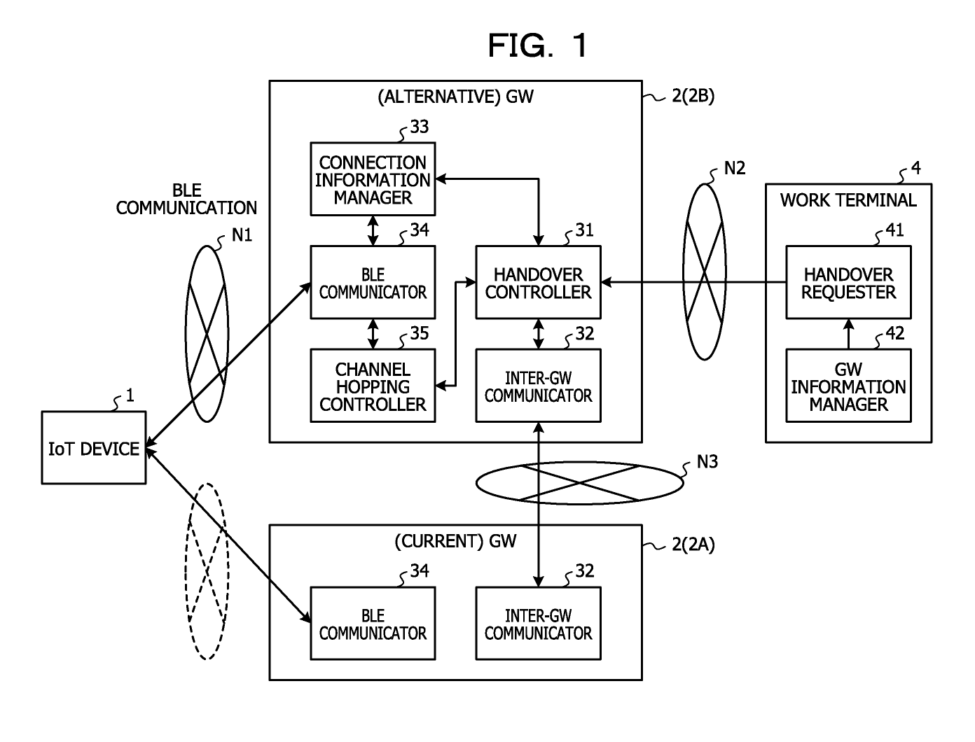

FIG. 1 illustrates an example of a configuration of a communication system according to the first embodiment. FIG. 1 illustrates a GW 2 executing BLE communication with an IoT device 1 (hereinafter referred to as “device 1”) via a network (BLE network) N1, and a work terminal 4 (hereinafter referred to as “terminal 4”). As multiple GWs 2, the GW 2A (current GW) communicating with the device 1, and a GW 2B as an alternative to the GW 2A, are illustrated. The IoT device 1 is an example of “equipment”, a “device”, an “extension”, or a “slave”. The GWs 2 are an example of “communication devices”, “relay devices”, “base units”, or “masters”. The terminal 4 is an example of a “terminal”. The GW 2A is an example of a “first communication device”. The GW 2B is an example of a “second communication device”. The device 1 hosted by the GW 2A is an example of a “first device”. The terminal 4 is an example of a “managing device”.

The terminal 4 is connected to a GW 2 via a network N2. For example, a wireless local area network (LAN), a third-generation (3G) wireless communication network, a wired LAN, serial communication, or the like may be used as the network N2. The GW 2A and the GW 2B are connected to each other via a network N3. The network N3 may be the same as the network N2. In addition, a wired LAN or Wi-Fi may be used as the network N3.

The GW 2A and the GW 2B have the same configuration. The GW 2B is described as an example. The GW 2B includes a handover controller 31, an inter-GW communicator 32, a connection information manager 33, a BLE communicator 34, and a channel hopping controller (CH controller) 35. An illustration of the sections that are included in the GW 2A illustrated in FIG. 1 and exclude the inter-GW communicator 32 and the BLE communicator 34 is omitted. The handover controller 31 (CPU 201) is an example of an “acquirer”, a “selector”, a “transmitter”, a “communicator”, or a “controller”.

The terminal 4 includes a handover requester 41 and a GW information manager 42. The handover requester 41 transmits, to the GW 2B (alternative GW), an instruction to host the predetermined device 1 hosted by the GW 2A (current GW). The GW information manager 42 manages information such as an address related to the GW (GW 2A) to be managed.

The handover controller 31 receives the handover instruction, transmits instructions to the inter-GW communicator 32, the connection information manager 33, the CH controller 35, and the like that are included in the GW 2B, and executes a handover process. The inter-GW communicator 32 executes secure communication with the other GW (GW 2A). The connection information manager 33 manages an address identifying a connection between the device 1 and the GW 2 and an encryption key. The BLE communicator 34 establishes a BLE connection to the device 1 and executes BLE communication. The CH controller 35 manages channels to be used for channel hopping and controls a hopping pattern of the channel hopping and the timing of the channel hopping.

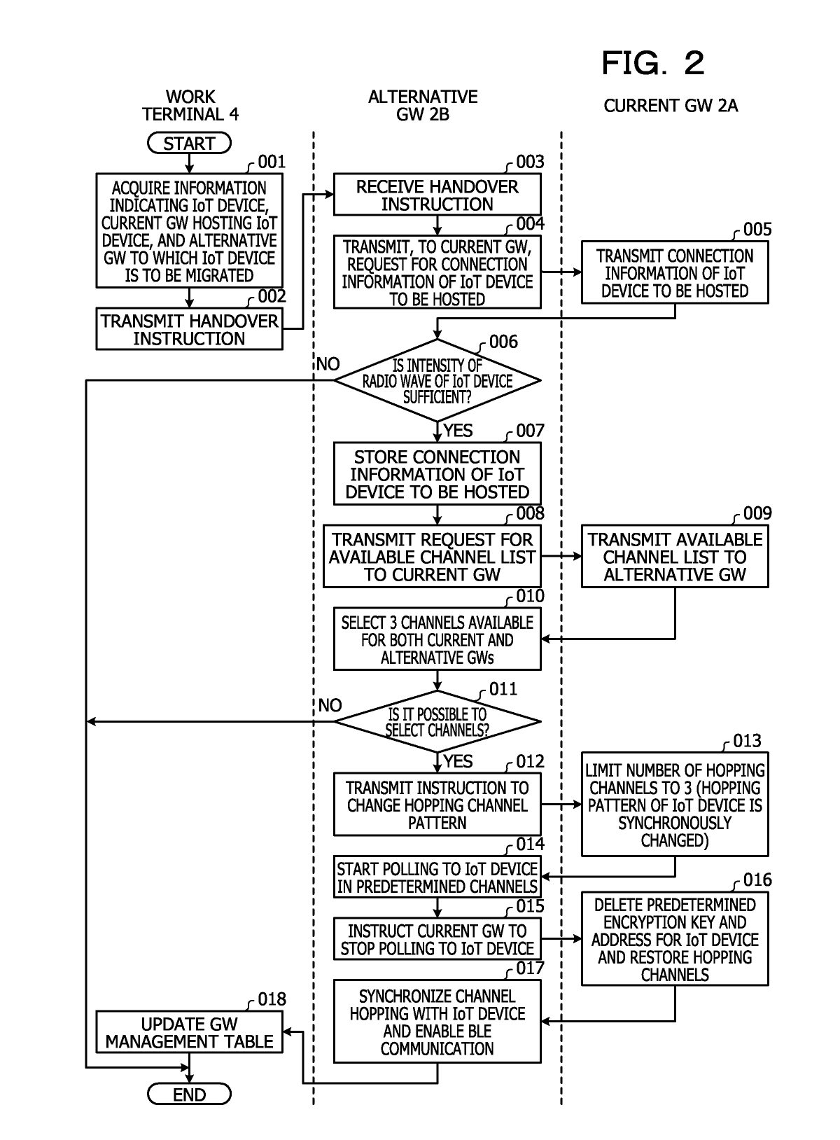

Operations to be executed upon the handover according to the first embodiment are as follows. FIG. 2 is a flowchart of an example of the operations according to the first embodiment. It is preferable that the worker perform authentication on the terminal 4 for the use of the terminal 4 in advance and confirm whether or not the worker has the right to perform the handover.

When the handover is started, the GW information manager 42 of the terminal 4 acquires an address of the alternative GW (GW 2B) by which the device 1 to be handed over is to be hosted, and an address of the current GW (GW 2A) currently hosting the device 1 (in 001 illustrated in FIG. 2). The GW information manager 42 manages a GW management table T1.

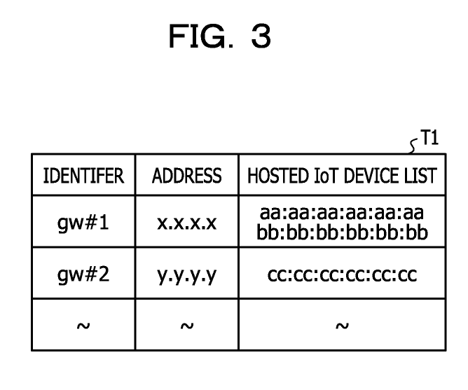

FIG. 3 illustrates an example of a data structure of the GW management table T1. The GW management table T1 is used to manage addresses (for example, Internet Protocol (IP) addresses) of GWs hosting IoT devices. The GW management table T1 stores, for each of the GWs, the identifier of the GW, the address of the GW, and a list of IoT devices hosted by the GM The list of the IoT devices includes Bluetooth (registered trademark) device addresses (BD addresses) of the IoT devices and information of encryption keys. The GW management table T1 may be used to manage vendor names and model numbers of the GWs. The GW management table T1 may be stored outside the terminal 4 (for example, may be stored in a network (cloud)).

The handover requester 41 transmits, to the GW 2B (alternative GW), an instruction (handover instruction) to host the predetermined device 1 instead of the GW 2A (in 002 illustrated in FIG. 2). The communication between the terminal 4 and the GW 2B is encrypted and the predefined terminal 4 uses a certificate, an ID, and a password to access the GW 2B.

The GW 2B receives the handover instruction (in 003 illustrated in FIG. 2). The handover controller 31 of the GW 2B transmits a request for connection information to the connection information manager 33 (not illustrated) of the GW 2A (current GW) via the inter-GW communicator 32 (in 004 illustrated in FIG. 2). The connection information manager 33 (not illustrated) of the GW 2A that has received the request transmits, to the GW 2B, the connection information (an encryption key and address (any or a combination of a BD address and an access address) of the device 1 to be hosted) requested via the inter-GW communicator 32 (in 005 illustrated in FIG. 2). The communication between the GW 2B and the GW 2A is encrypted and the GW 2A uses a certificate an ID, and a password to confirm that the GW 2B is a predefined GW 2.

The handover controller 31 determines whether or not the intensity of a radio wave from the device 1 is sufficient (or is equal to or larger than a predetermined threshold) (in 006 illustrated in FIG. 2). If the handover controller 31 determines that the intensity of the radio wave is smaller than the threshold, a process illustrated in FIG. 2 is terminated. This is due to the fact that the GW 2B is not suitable as a connection destination. On the other hand, if the handover controller 31 determines that the intensity of the radio wave is equal to or larger than the threshold, the handover controller 31 passes the acquired connection information to the connection information manager 33. The connection information manager 33 stores the connection information (in 007 illustrated in FIG. 2).

The handover controller 31 of the GW 2B transmits a request for a current available channel list to the CH controller 35 of the GW 2A via the inter GW communicator 32 (in 008 illustrated in FIG. 2). The GW 2A that has received the request transmits the requested available channel list via the inter-GW communicator 32 (in 009 illustrated in FIG. 2).

The handover controller 31 of the GW 2B acquires an available channel list from the CH controller 35 of the GW 2B, crosschecks the available channel list with the available channel list acquired from the GW 2A, and selects a predetermined number (for example, 3) of channels available for both GWs (in 010 illustrated in FIG. 2). The handover controller 31 determines whether it is possible to select the channels (in 011 illustrated in FIG. 2). If the handover controller 31 determines that it is not possible to select the channels, the handover controller 31 terminates the process.

If the three channels are selected, the handover controller 31 transmits an instruction to change available channels to the three channels selected for a hopping pattern to the GW 2A via the inter-GW communicator 32 (in 012 illustrated in FIG. 2).

When receiving the instruction, the handover controller 31 of the GW 2A instructs the CH controller 35 to change the hopping channels (to the selected three channels). The CH controller 35 limits the hopping channels to the three channels in accordance with the instruction (in 013 illustrated in FIG. 2). Then, a hopping pattern of the device 1 is synchronously changed by the communication with the device via the BLE communicator 34 of the GW 2A. Actually, an instruction to change the hopping pattern is transmitted to the device 1 in accordance with specifications of the BLE communication.

The handover controller 31 of the GW 2B gives an instruction to start polling to the device 1 to the connection information manager 33 of the GW 2B. Thus, the BLE communicator 34 of the GW 2B uses the connection information stored in the connection information manager 33 to start the polling to the device 1 in accordance with the channel hopping controlled by the CH controller 35 (in 014 illustrated in FIG. 2).

The handover controller 31 of the GW 2B transmits an instruction to stop the polling to the device 1 to the GW 2A (in 015 illustrated in FIG. 2). In the GW 2A, the handover controller 31 instructs the connection information manager 33 to delete the connection information (encryption key and address) of the device 1 and instructs the CH controller 35 to restore the hopping pattern. Then, the BLE communicator 34 of the GW 2A stops the polling to the predetermined device 1 and restores the communication to the BLE communication using the original hopping pattern.

On the other hand, in the GW 2B, the hopping pattern of the GW 2B upon the start of the polling may deviate from the hopping pattern of the device 1. However, a transmit window is modified in a short time period and the hopping patterns are synchronized with each other. When the synchronization is completed, the handover controller 31 of the GW 2B instructs the CH controller 35 to restore the hopping pattern. Then, the hopping pattern of the device 1 is synchronously changed, and the communication may be executed using the original pattern (in 017 illustrated in FIG. 2). Lastly, the terminal 4 updates the GW management table T1 of the GW information manager 42 of the terminal 4 (in 018 illustrated in FIG. 2).

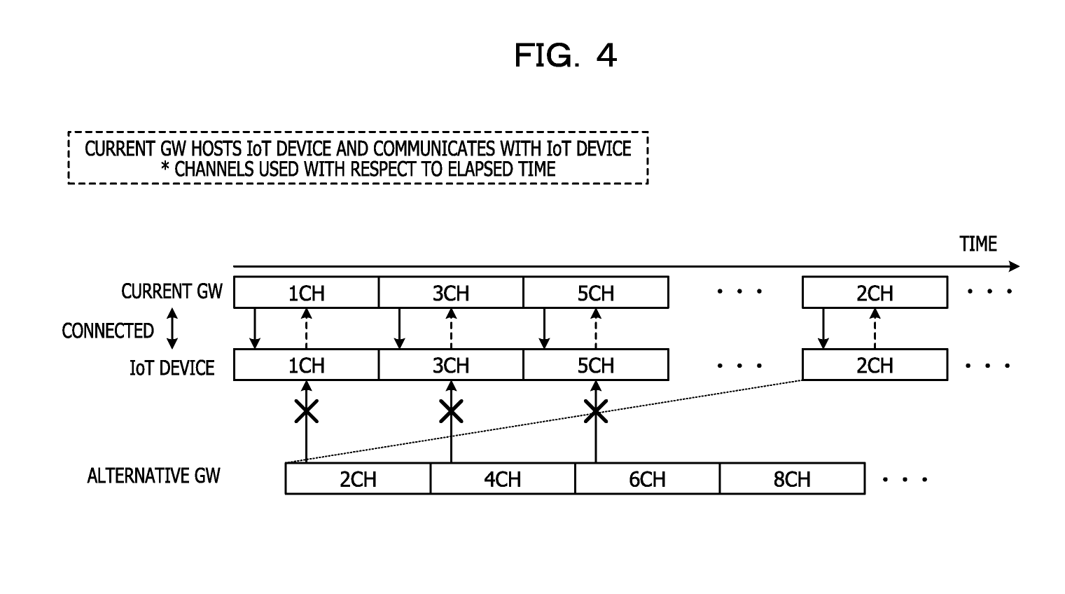

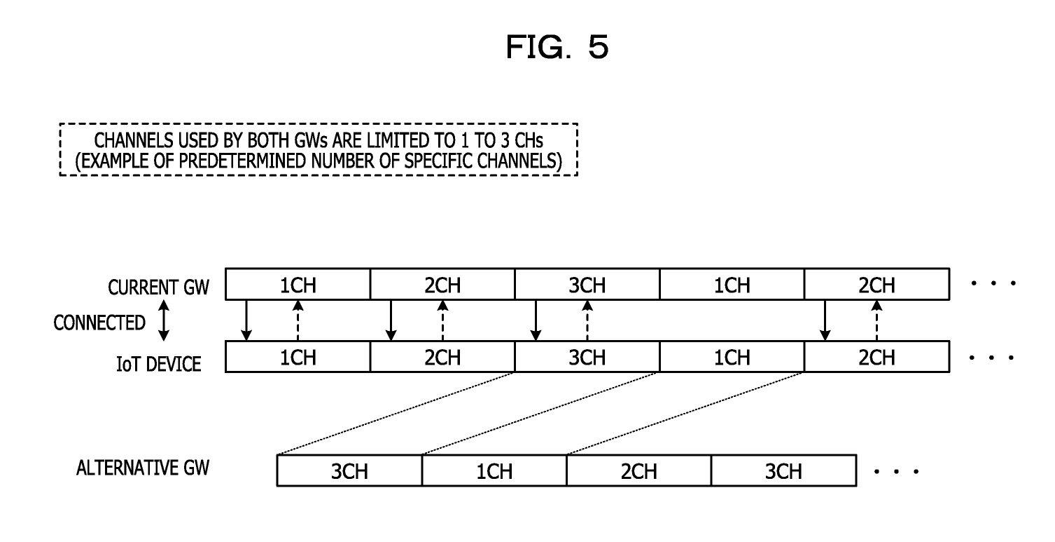

FIG. 4 illustrates a state in which the current GW (GW 2A) communicates with the device 1, while FIG. 5 illustrates a state in which channels used by the current GW (GW 2A) and the alternative GW (GW 2B) are limited.

FIG. 4 illustrates an example in which the GW 2A and the device 1 communicate with each other using a hopping pattern including 1CH, 3CH, 5CH, . . . . In this case, the GW 2B uses a hopping pattern including 2CH, 4CH, 6CH, 8CH, . . . . Since the hopping pattern used by the GW 2B significantly deviates from the hopping pattern used by the device 1, the GW 2B does not communicate with the device 1.

In the first embodiment, as illustrated in FIG. 5, channels to be used by each of the GWs 2A and 2B are limited to the predetermined number (for example, 3) of specific channels (1CH, 2CH, and 3CH) by the operations illustrated in FIG. 2. The channels to be used are limited by Adaptive Frequency Hopping (AFH). 1CH, 2CH, and 3CH are an example of a predetermined number (3) of specific channels. The predetermined number, however, may be larger or smaller than 3. For example, the predetermined number may be equal to or smaller than 5 (or may be any of 5, 4, 3, 2, and 1) or may be equal to or smaller than 10 (or may be any of 10, 9, 8, 7, and 6).

Then, the deviation between the channel hopping patterns of the GWs 2A and 2B is reduced. This is due to the fact that, if the number of available channels is small, the channel hopping patterns (including the timing) are nearly the same.

In addition, the hopping pattern of the device 1 is synchronized with and changed to the hopping pattern of the GW 2A by AFH. Thus, the hopping pattern of the device 1 may be close to the hopping pattern of the GW 2B (alternative GW). According to the specifications of BLE, if the deviation of the timing of the channel hopping is small, the transmit window is automatically modified and it becomes possible to execute the communication. Thus, the device 1 may communicate with the GW 2B without being disconnected.

### Effects of First Embodiment

According to the first embodiment, the alternative GW (GW 2B) acquires, from the current. GW (GW 2A), the information (connection information: encryption key and either or both of BD address and access address) identifying the connection relationship between the device 1 and the GW 2A. In addition, the GW 2B sets the number of channels to be used to the predetermined number and causes the hopping patterns of the device 1 and the GW 2B to become nearly the same. Thus, the synchronization (reduction in the deviation between the hopping patterns) between the GW 2B and the device 1 may be achieved.

Since the GW 2B uses the same connection information as that used by the GW 2A, the device 1 may continue to execute the communication while treating the GW 2B as a base unit (GW 2A). As a result, the base unit is switched while the device 1 does not recognize the switching of the base unit (from the GW 2A to the GW 2B). Thus, a disconnection does not occur between the device 1 and the GWs 2, and paring tasks such as “Passkey Entry”, “Numeric Comparison”, and “Out-of-band” are not performed. Since the alternative GW (GW 2B) takes over the encryption key used between the device 1 and the GW 2A, the security is not reduced.

Thus, according to the first embodiment, a device 1 hosted by a GW 2 may be hosted by another GW 2 with the simple method without a reduction in the security while not becoming inaccessible. Specifically, according to the first embodiment, a load caused by a change in a connection destination of the device 1 may be reduced.

<Hardware Configurations>

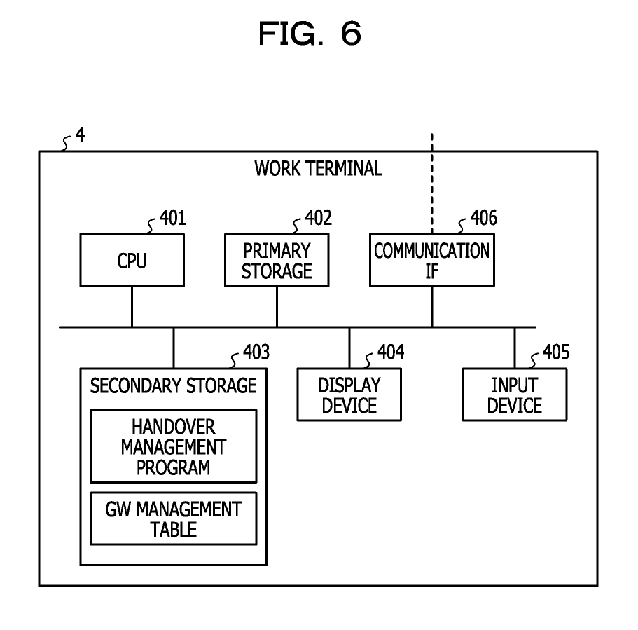

Hardware configurations of the terminal 4, the GWs 2, and the device 1 are described below. FIG. 6 illustrates an example of a hardware configuration of the work terminal. The work terminal 4 includes a central processing unit (CPU) 401, primary storage 402, secondary storage 403, a display device 404, an input device 405, and a communication interface (communication IF) 406 that are connected to each other via a bus.

The primary storage 402 is a storage device to be used as a region in which a program is loaded, a work region of the CPU 401, a region for storing data and the program, or a buffer region. The primary storage 402 is, for example, a random access memory (RAM) or formed by combining a RAM with a read only memory (ROM).

The secondary storage 403 is a storage device to be used as a region for storing data and the program. The secondary storage 403 stores a handover management program, the GW management table T1, and the like. The handover management program is executed by the CPU 401, and the terminal 4 executes the operations illustrated in FIG. 2.

The secondary storage 403 is, for example, a nonvolatile storage medium such as a hard disk drive (HDD), a solid state drive (SSD), a flash memory, or an electrically erasable programmable read-only memory (EEPROM). The secondary storage 403 may include portable storage media such as a disk-type storage medium and a USB memory.

The display device 404 displays information and data. The input device 405 is used to input information. The input device 405 is, for example, keys, buttons, a pointing device (mouse or the like), a touch panel, or the like. A user interface (UI) is provided by the input device 405 and the display device 404. The communication IF 406 is a circuit that executes a communication process. For example, a network interface card (NIC) may be used as the communication IF 406.

The CPU 401 loads programs (including an operating system and the handover management program) stored in a memory (any or a combination of the primary storage and the secondary storage) and executes the programs. By executing the programs, the CPU 401 of the terminal 4 operates as the GW information manager 42 and the handover requester 41 and executes the operations illustrated in FIG. 2.

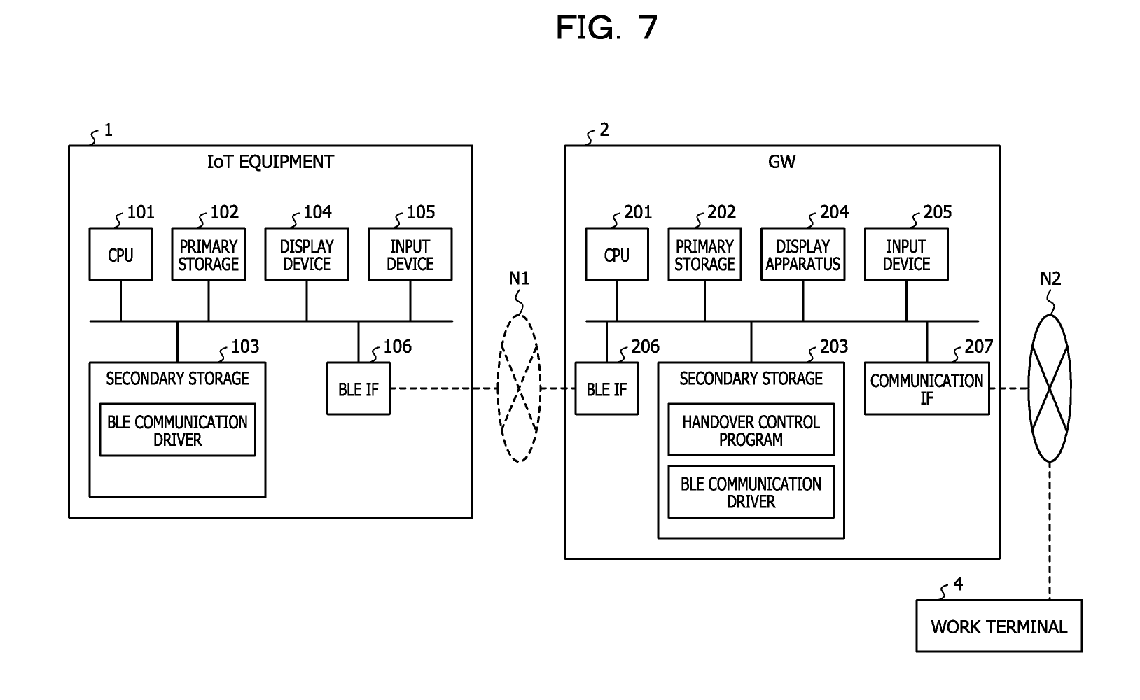

FIG. 7 illustrates an example of hardware configurations of the GWs and the IoT device. Each of the GWs 2 includes a CPU 201, primary storage 202, secondary storage 203, a display device 204, an input device 205, a BLE interface (BLE IF) 206, and a communication interface (communication IF) 207 that are connected to each other via a bus.

The CPU 201, the primary storage 202, the secondary storage 203, the display device 204, the input device 205, and the communication IF 207 have functions that are the same as or similar to those included in the CPU 401, the primary storage 402, the secondary storage 403, the display device 404, the input device 405, and the communication IF 406. The BLE IF 206 is a BLE communication circuit.

The secondary storage 203 stores a handover control program, a BLE communication driver, and the like. The handover control program and the BLE communication driver are executed by the CPU 201. By executing the handover control program and the BLE communication driver, the CPU 201 operates as the handover controller 31, the inter-GW communicator 32, the connection information manager 33, the BLE communicator 34, and the channel hopping controller (CH controller) 35 and executes the operations illustrated in FIG. 2.

The IoT device 1 includes a CPU 101, primary storage 102, secondary storage 103, a display device 104, an input device 105, and a BLE IF 106 that are connected to each other via a bus. The CPU 101, the primary storage 102, the secondary storage 103, the display device 104, and the input device 105 have functions that are the same as or similar to those included in the those included in the CPU 401, the primary storage 402, the secondary storage 403, the display device 404, and the input device 405. The BLE IF 106 is a BLE communication circuit.

The secondary storage 103 stores a program to be executed as the IoT device, a BLE communication driver, and the like. The program and the BLE communication driver are executed by the CPU 101. Thus, the device 1 acquires desired data (for example, data detected by a sensor (not illustrated)) and transmits the acquired data to a GW 2 (base unit).

Each of the primary storage 402, the primary storage 202, the primary storage 102, the secondary storage 403, the secondary storage 203, and the secondary storage 103 is an example of a “storage device”, a “storage medium”, a “memory”, or a “storage unit”. Primary storage and secondary storage are referred to as “memory” in some cases.

Each of the CPU 401, the CPU 201, and the CPU 101 is an example of a “control device”, a “control unit”, a “controller”, or a “processor”. Each of the CPUs may be referred to as microprocessor (MPU) or processor. Each of the CPUs is not limited to a single processor and may be a multi-processor. In addition, a single CPU connected to a single socket may have a multi-core configuration. A part or all of processes to be executed by the CPUs may be executed by a processor other than a CPU or by, for example, a dedicated processor such as a digital signal processor (DSP), a graphics processing unit (GPU), a numerical processor, a vector processor, or an image processor.

In addition, a part or all of the processes to be executed by the CPUs may be executed by an integrated circuit (IC) or another digital circuit. Furthermore, the integrated circuit or the digital circuit may include an analog circuit. The integrated circuit includes an LSI, an application specific integrated circuit (ASIC), and a programmable logic device (PLD). The PLD includes, for example, a field-programmable gate array (FPGA). A part or all of the processes to be executed by the CPUs may be executed by a combination of a processor and the integrated circuit. The combination is referred to as microcontroller (MCU), system-on-chip (SoC), system LSI, chip set, or the like, for example.

Although the first embodiment describes the example in which the handover instruction is transmitted by the terminal 4 to the alternative GW 2 (GW 2B), the handover instruction may be transmitted to the current GW 2 (GW 2A). In this case, the GW 2A communicates with the GW 2B and transmits the connection information to the GW 2B. Processes to be executed after the transmission are the same as those illustrated in FIG. 2.

### Second Embodiment

A second embodiment is described below. Since the second embodiment describes configurations common to those described in the first embodiment, a description of common features is omitted and different features are mainly described. In the first embodiment, the terminal 4 is used to transmit, to the GW 2B, the handover instruction including the information specifying the device 1 to be handed over and the GW 2B by which the device 1 is to be hosted.

In the second embodiment, processing loads of the GWs 2 are collected by a GW managing server. The GW managing server determines a hosting destination for hosting a device 1 so that the processing loads of the GWs 2 are equal to each other, and the GW managing server causes the device 1 to be automatically handed over. This may avoid delays of processes (data collection and transmission) of IoT device.

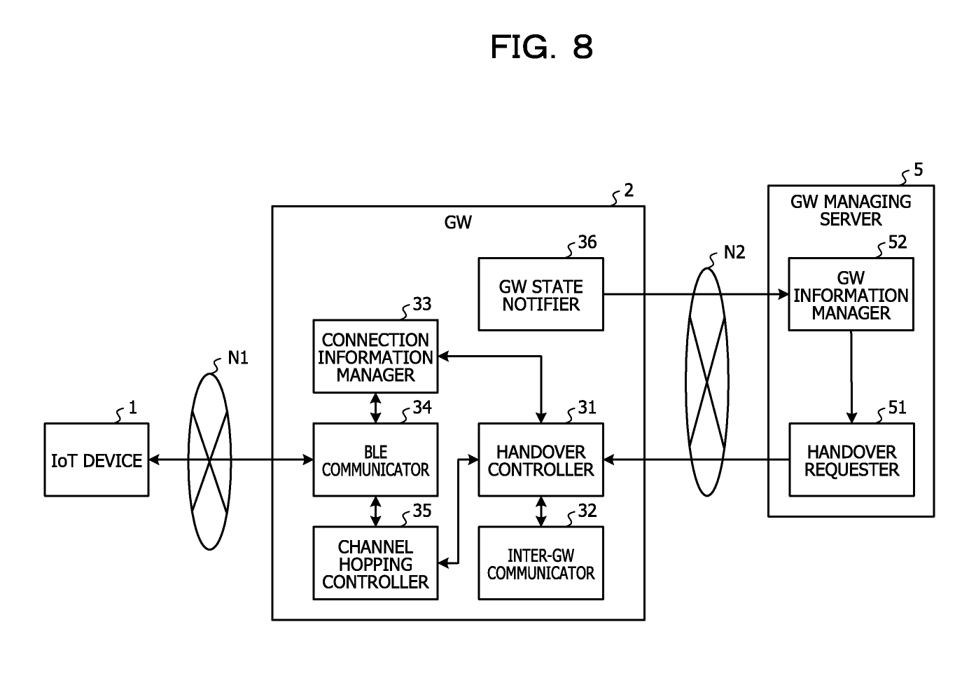

FIG. 8 illustrates an example of a configuration of a communication system according to the second embodiment. FIG. 8 exemplifies a single GW 2, since the configuration of the current GW is the same as the configuration of the alternative GW. The features of the second embodiment that are different from those described in the first embodiment are as follows. The GW managing server 5 (hereinafter merely referred to as “server 5”) is used instead of the work terminal 4.

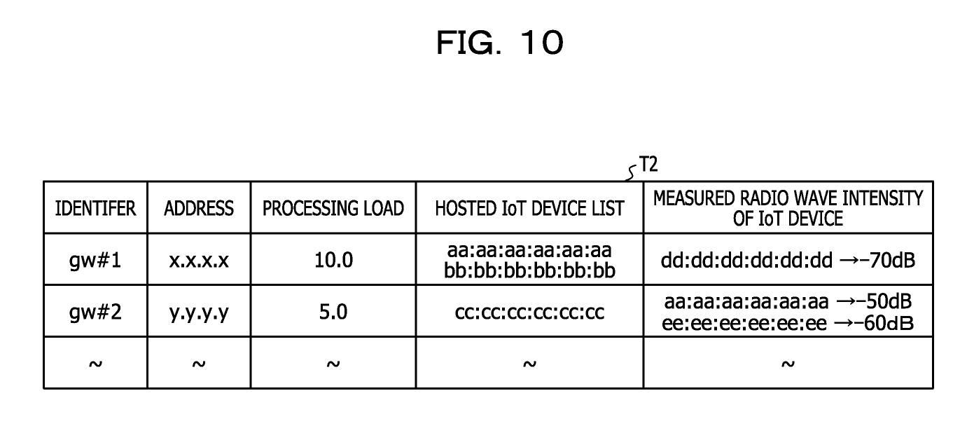

A general-purpose or dedicated computer (information processing device) having the constituent elements illustrated in FIG. 6 may be used as the server 5. The CPU 401 of the computer to be used as the server 5 executes a program stored in a memory, thereby operating as a handover requester 51 and a GW information manager 52. In addition, a GW management table T2 (illustrated in FIG. 10) is stored in the memory (any or a combination of the primary storage 402 and the secondary storage 403) of the server 5. The server 5 is an example of a “managing device”. The handover requester 51 (CPU 401) is an example of an output section that outputs a handover instruction.

In addition, each of the GWs 2 includes a GW state notifier 36. The CPU 201 of each of the GWs 2 may operate as the GW state notifier 36 by executing the program. The GW state notifier 36 regularly measures a processing load of the GW 2 and transmits information of the processing load to the server 5. In addition, the GW state notifier 36 executes a process of transmitting, to the server 5, the intensity of a radio wave from a device 1 connected to another GW, and the like.

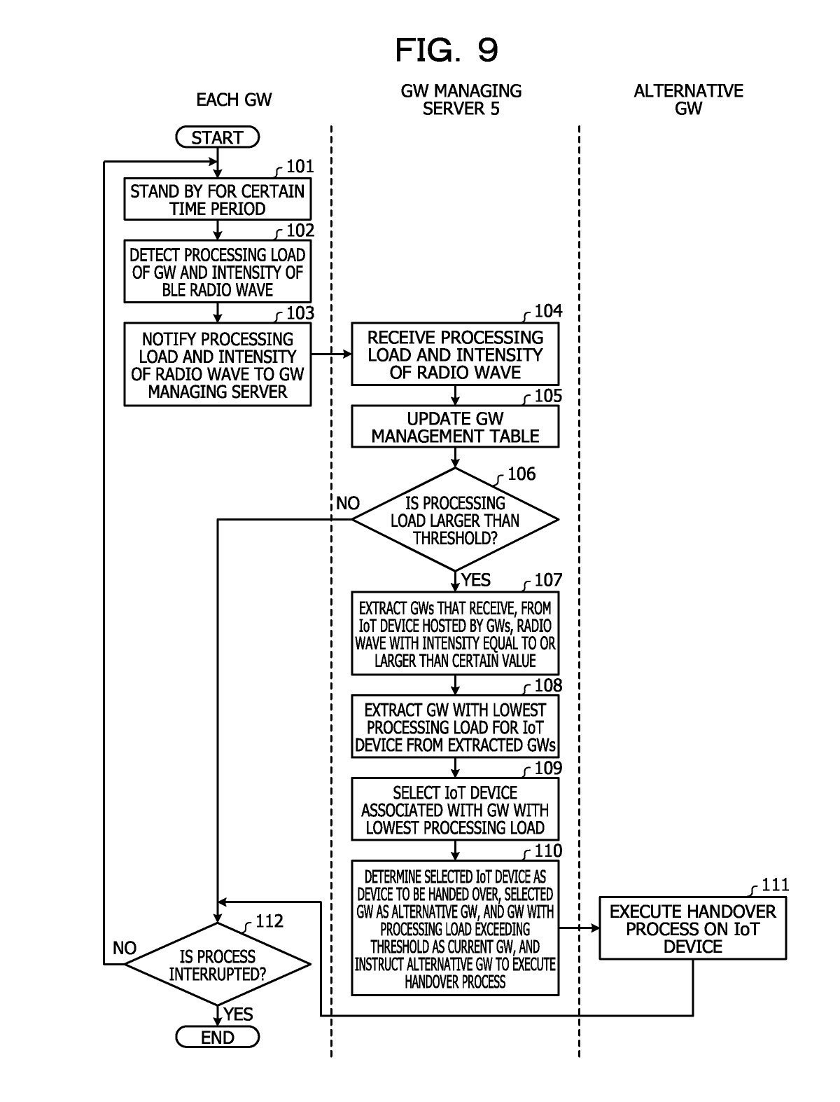

FIG. 9 is a flowchart of an example of operations (handover process) according to the second embodiment. Each GW 2 stands by for a certain time period (in 101 illustrated in FIG. 9). When the certain time period elapses, the following process is executed.

Specifically, when the certain time period elapses, the GW state notifier 36 (CPU 201) measures a processing load of the target GW 2. In addition, the GW state notifier 36 acquires the result of measuring the intensity of a BLE radio wave (radio wave from a device 1 connected to another GW) (in 102 illustrated in FIG. 9). The GW state notifier 36 (CPU 201) transmits information indicating the processing load and the intensity of the radio wave to the server 5 (in 103 illustrated in FIG. 9).

The server 5 sends the information received from the GW 2 and indicating the processing load and the intensity of the radio wave to the GW information manager 52. In this case, the server 5 receives the information indicating the processing load and the intensity of the radio wave (in 104 illustrated in FIG. 9), and the information indicating the processing load and the intensity of the radio wave is sent to the GW information manager 52.

The GW information manager 52 manages the GW information management table T2. FIG. 10 illustrates an example of a data structure of the GW information management table T2 (table T2). The table T2 stores the following record (entry) for each GW. The record stores an identifier of a GW, an address, a processing load, a hosted IoT device list, and the intensity of a measured radio wave of an IoT device (connected to anther GW). The intensity of the radio wave is associated with a BD address of the target IoT device and stored.

A BLE packet transmitted by an IoT device does not include a BD address and includes an access address. An IoT device to be handed over is hosted by any of the GWs, and the GW manages an association, relationship between a BD address of the IoT device and an access address. Thus, the BD address may be identified from the access address. In other words, the server 5 stores, in the table T2, the BD address obtained based on information stored in the memory of the GW and indicating the association relationship between the BD address and the access address.

The GW information manager 52 (CPU 401, hereinafter also referred to as “manager 52”) uses the information indicating the processing load and the intensity of the radio wave to update the table T2 (in 105 illustrated in FIG. 105).

The manager 52 determines whether or not the processing load is larger than a threshold (stored in the memory in advance) (in 106 illustrated in FIG. 9). If the manager 52 determines that the processing load is not larger than the threshold, the process proceeds to 112. On the other hand, if the manager 52 determines that the processing load is larger than the threshold, the process proceeds to 107.

In process 107, the manager 52 selects a device 1 to be handed over and GWs 2 (GWs 2 corresponding to the GW 2B), each of which may serve as an alternative GW. For example, if a processing load of a GW 2 having an identifier “gw #1” is larger than the threshold, the manager 52 extracts a GW 2 that has measured the intensities, equal to or larger than a certain value, of radio waves from devices 1 hosted by the GW 2 having the identifier “gw #1”.

The manager 52 extracts, as an alternative GW, a GW 2 (for example, a GW 2 with the lowest processing load) with a low processing load from the GWs extracted in 107 (in 108 illustrated in FIG. 9). The manager 52 selects a device associated with the GW 2 (alternative GW 2) extracted in 108 as a device 1 of which a connection destination is to be changed (in 109 illustrated in FIG. 9).

The manager 52 determines the device 1 selected in 109 as a device 1 to be handed over and determines the GW extracted in 108 as the alternative GW. The handover requester 51 specifies the determined device 1 and the current GW (GW 2 with a processing load larger than the threshold) and instructs the alternative GW to execute the handover (in 110 illustrated in FIG. 9). The alternative GW executes processes that are the same as or similar to processes 003 and later described in the first embodiment (a detailed description thereof is omitted to avoid duplication). Each of the GWs 2 determines whether or not an event that interrupts the handover process has occurred (in 112 illustrated in FIG. 9). If each of the GWs 2 determines that the process is interrupted, the process is terminated. If each of the GWs 2 determines that the process is not interrupted, the process returns to 101.

Effects that are the same as or similar to those described in the first embodiment may be obtained in the second embodiment. In addition, according to the second embodiment if the state of a GW 2 satisfies a predetermined requirement (for example, if a processing load is equal to or larger than the threshold), the GW 2 is treated as a current. GW, an alternative GW by which a device hosted by the current GW is to be hosted is selected, and a handover instruction is transmitted to the alternative GW. Thus, the handover instruction is automatically transmitted to the alternative GW 2. Specifically, an operation of the terminal 4 is not executed.

In the description of the example of the operations according to the second embodiment, whether or not the handover is to be executed is determined based on the processing load of the GW 2. Process 106 (of determining whether or not the processing load is larger than the threshold) is an example of the determination of “whether or not a predetermined requirement is satisfied”. If the intensity of a radio wave of a hosted device 1 is smaller than the threshold, and a packet error rate increases, it may be determined that the handover is to be executed. Specifically, process 107 illustrated in FIG. 9 is a process of determining “whether or not the intensity of a radio wave of a hosted device is smaller than (or lower than) the threshold” or “whether or not a packet error rate exceeds a threshold”. Alternatively, process 107 illustrated in FIG. 9 may be a process of determining “whether or not the intensity of a radio wave of a hosted device is lower than the threshold and whether or not a packet error rate exceeds the threshold”.

In addition, process 107 illustrated in FIG. 9 may be a process of determining “whether or not the amount of traffic (passing via the GW 2) has exceeded a threshold”. In this case, information to be transmitted by the GW state notifier 36 of the GW 2 to the server 5, and the data structure of the table T2 managed by the server 5, are changed based on the details of the information to be used for the determination.

The second embodiment exemplifies the configuration of the GW managing server 5 independent of the GWs 2. Each of the GWs 2, however, may have the functions of the GW managing server 5 (or each of the communication devices may include the managing device). While the GWs may collaborate with each other, a device 1 to be handed over and an alternative GW may be determined.

### Third Embodiment

A third embodiment is described below. Since the third embodiment describes configurations common to those described in the first and second embodiments, a description of common features is omitted and different features are mainly described. The CPU 101 of the device 1 executes an application and regularly or periodically collects predetermined data (for example, sensor data or data other than sensor data).

In the communication systems according to the first and second embodiments, an application server (app server) is connected to a GW 2 via the network N2, for example. The app server regularly accesses the device 1 via the GW 2 and collects data from the device 1. In the first and second embodiments, the handover is executed without consideration of the data collection by the app server.

Thus, the timing of the access to the device 1 may overlap the time when the handover is executed, and the data collection may not be appropriately executed. In the third embodiment, the GW 2 executes control to execute the handover in consideration of an operation of the app server so that the timing of the handover does not affect the data collection.

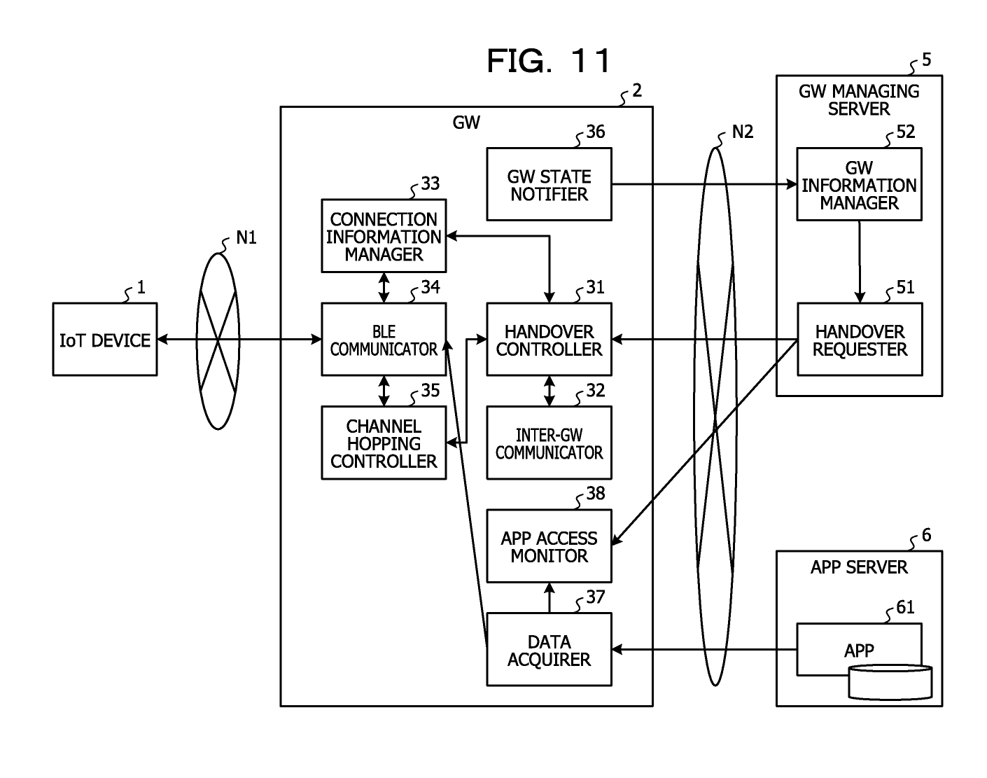

FIG. 11 illustrates an example of a configuration of a communication system according to the third embodiment. In FIG. 11, the GW 2 is connected to an application server 6 (app server 6, hereinafter referred to as server 6) via the network N2. A computer (information processing device) having the same hardware configuration (illustrated in FIG. 6) as that of the terminal 4 is used as the server 6.

In a memory (any or a combination of the primary storage 402 and the secondary storage 403) of the server 6, programs including an application 61 are stored. The CPU 401 of the server 6 executes the application 61. The application 61 is a program to be executed to collect data acquired by the device 1. By executing the application 61, the server 6 accesses the device 1 via the GW 2 and collects the data acquired by the device 1 periodically, or regularly, or in response to the occurrence of an event. The CPU 401 operates as the application 61.

The GW 2 includes a data acquiring section 37 (acquiring section 37) and an app access monitor 38 (monitor 38), as well as the configuration (illustrated in FIG. 8) described in the second embodiment. The CPU 201 executes a program, thereby operating as the acquiring section 37 and the monitor 38.

The acquiring section 37 receives a data acquisition request from the server 6. The GW 2 acquires data from the device 1 via the BLE communicator 34 and transmits the data to the server 6 (application 61).

The monitor 38 collects, from the application 61, information indicating intervals (access cycles) at which a request reaches the data acquiring section 37 from the application 61. The monitor 38 estimates time until the next access timing (time when the request reaches the data acquiring section 37). If multiple applications 61 use the same device 1, the next access timing is estimated based on access cycles of the applications 61.

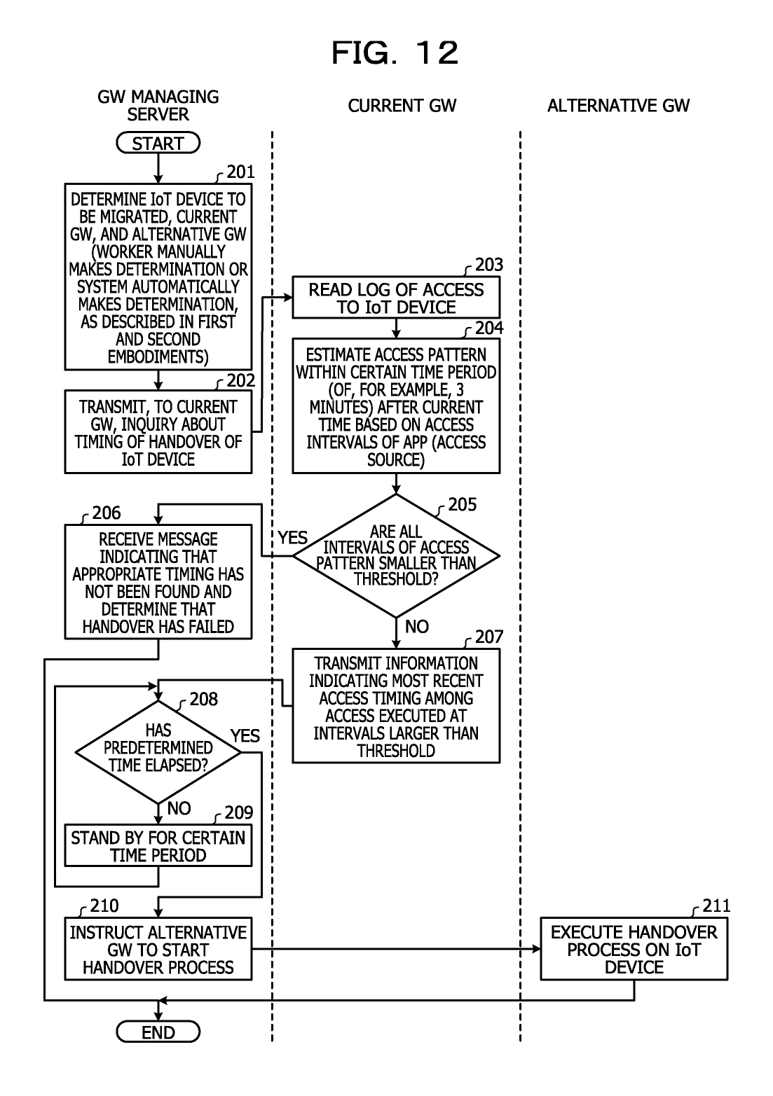

FIG. 12 is a flowchart of an example of operations according to the third embodiment. In process 201, the manager 52 of the server 5 determines a device 1 to be migrated, a current GW, and an alternative GW. A method for the determination may be the same as the method described in the first embodiment or the method described in the second embodiment.

In process 202, the handover requester 51 (CPU 401) of the server 5 transmits, to the monitor 38 of the current GW, an inquiry about the timing of the handover of the device 1. In the current. GW that has received the inquiry, the handover controller 31 reads, from the memory of the current GW, a log of access to the device 1 (in 203), for example.

In process 204, the monitor 38 estimates an access pattern (access timing or time when access is executed one or more times) within a certain time period (of, for example, 3 minutes) after the current time based on access intervals at which an access source (for example, application 61) executes access.

In process 205, the monitor 38 determines whether or not all intervals between the access timing of the access pattern are smaller than a threshold. If the monitor 38 determines that all the intervals are smaller than the threshold, the process proceeds to 207. If not all the intervals are smaller than the threshold, the process proceeds to 206.

In process 206, the server 5 receives, from the monitor 38 of the current GW, a message indicating that appropriate handover timing has not been found, and determines that the handover has failed. Then, the server 5 terminates the process.

In process 207, the monitor 38 transmits, to the server 5, information indicating the most recent access timing (an example of “the timing of access to the device 1 via the first communication device 2A within a predetermined time period”) among access executed at intervals larger than the predetermined threshold.

In process 208, the server 5 determines whether or not predetermined time (the most recent access timing) has elapsed. If the server 5 determines that the predetermined time has not elapsed, the server 5 stands by for a certain time period (in 209), and the process returns to 208. If the server 5 determines that the predetermined time has elapsed, the handover requester 51 of the server 5 transmits an instruction (handover instruction) to start the handover to the alternative GW.

The alternative GW that has received the handover instruction executes processes that are the same as or similar to processes 003 and later described in the first embodiment (a detailed description thereof is omitted to avoid duplication). In this manner, in the third embodiment, the server 5 transmits the aforementioned instruction to the second communication device after the timing of access to the device 1 (first device 1) via the first communication device (2A).

In the third embodiment, the server 5 as the managing device transmits the handover instruction to the alternative GW (GW 2B: an example of the second communication device) after the timing of access to the device 1 (first device 1) via the current GW (GW 2A: an example of the first communication device).

According to the third embodiment, before the start of the handover, the handover requester 51 of the server 5 transmits, to the monitor 38 of the current GW, an inquiry about the access timing of the application 61 and transmits the handover instruction to the alternative GW after the access timing. Specifically, the handover requester 51 delays the handover instruction and avoids an interruption caused by access of the application 61. Thus, the data collection is appropriately executed.

### Fourth Embodiment

A fourth embodiment is described below. Since the fourth embodiment describes configurations common to those described in the first to third embodiments, a description of common features is omitted and different features are mainly described. The first to third embodiments assume the handover of a single device 1.

However, if a GW is replaced, all multiple devices 1 hosted by the GW to be replaced are handed over. In this case, the handover is executed on each of the multiple devices 1. The order in which the multiple devices 1 are handed over may affect the efficiency of a task of replacing the GW 2 or the data collection. In the fourth embodiment, the order in which the multiple devices 1 are handed over is determined based on communication states of the devices 1 and the usage state of the application 61.

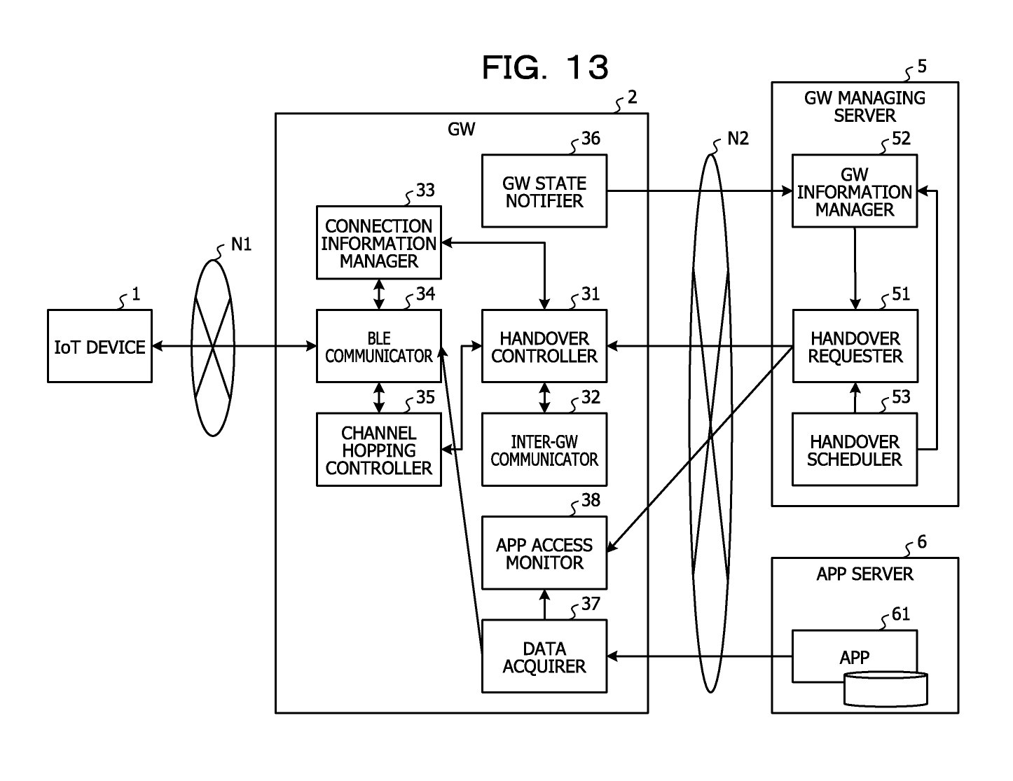

FIG. 13 illustrates an example of a configuration of a communication system according to the fourth embodiment. A feature different from the third embodiment (FIG. 11) is that the server 5 includes a handover scheduler 5 (hereinafter referred to as “scheduler 53”). Features other than the scheduler 53 are the same as those described in the third embodiment, and a description thereof is omitted. The CPU 401 of the server 5 operates as the scheduler 53 by executing a program.

When receiving an instruction (handover instruction) to execute migration from the current GW to the alternative GW, the scheduler 53 causes all devices 1 hosted by the current GW to be hosted by the alternative G. In this case, the scheduler 53 references communication states of the devices 1 and the usage state of the application 61.

In this case, a device 1 that is in a poor communication state and to be accessed by the application 61 after the elapse of a sufficient time period is selected on a priority basis and handed over. This is due to the fact that, if the communication state of a device 1 is poor, retransmission may be executed many times, the response performance may be reduced, and the communication of another device 1 may be inhibited.

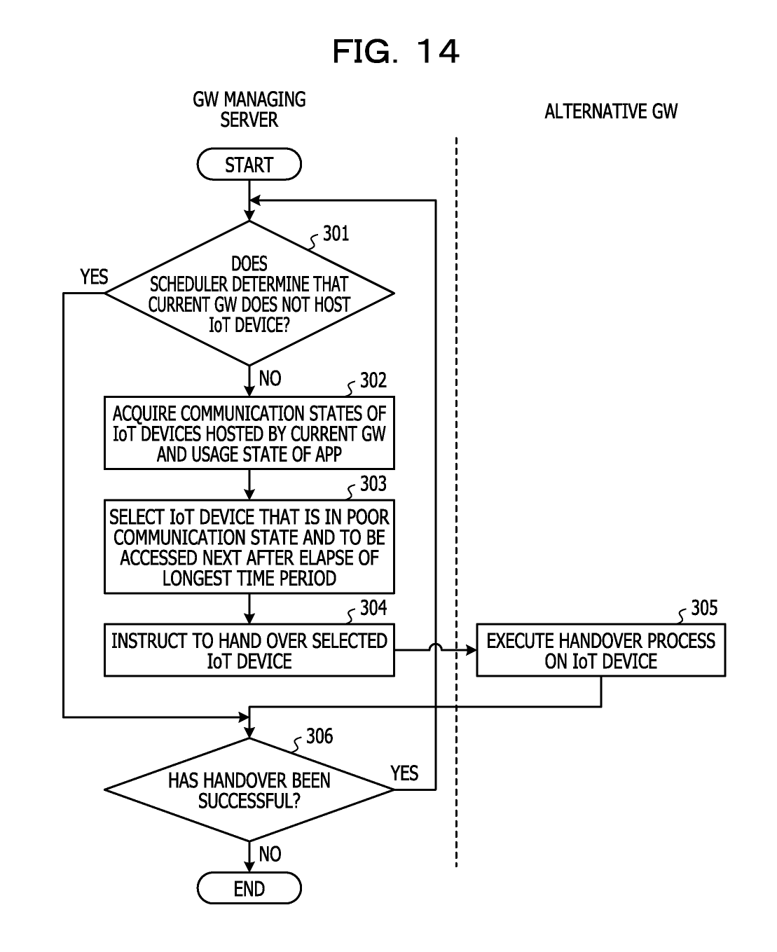

FIG. 14 is a flowchart of an example of operations according to the fourth embodiment. In process 301, the scheduler 53 of the server 5 determines whether or not the current GW does not host a device 1. If the scheduler 53 determines that the current GW does not host a device 1, the process proceeds to 306. If the scheduler 53 determines that the current GW hosts one or more devices 1, the process proceeds to 302.

In process 302, the scheduler 53 acquires communication states of devices 1 hosted by the current GW and the usage state of the application 61. The communication states may be calculated based on the intensities of radio waves, packet error rates, or the like, for example. A time period from the current time to the next access timing may be used as the usage state. Data indicating the communication states and the usage state is collected by and stored in the current GW.

In process 303, the scheduler 53 uses the communication states of the devices 1 and the usage state of the application 61 to select,as a device to be handed over from among the multiple devices 1, a device 1 that is in a poor communication state and to be accessed next after the elapse of a long time period.

For example, as a device 1 in a poor communication state, a device 1 in the poorest communication state is selected from among the multiple devices 1. However, as the device 1 in the poor communication state, a device other than the device 1 in the poorest communication state may be selected. In addition, for example, as a device 1 to be accessed after the elapse of a long time period, a device 1 to be accessed after the elapse of the longest waiting time period is selected from among the multiple devices 1. However, a device 1 other than the device 1 to be accessed after the elapse of the longest waiting time period may be selected.

In process 304, the handover requester 51 transmits, to the alternative GW, an instruction to hand over the device 1 selected in 303. Thus, processes 003 and later that are illustrated in FIG. 2 are executed (in 305 illustrated in FIG. 14, a detailed description is omitted to avoid duplication).

In process 306, the server 5 determines whether or not the handover has been successful. If the handover has been successful, the process returns to 301. If the handover has not been successful, the process is terminated.

According to the fourth embodiment, the scheduler 53 (CPU 201) determines a device that is in a poor communication state and is to be accessed after the elapse of a long time period (long time length) via the GW 2B, as a target device (first device 1) among two or more devices 1 hosted by and connected to the GW 2A or the connection destination to be changed.

According to the fourth embodiment, the scheduler 53 selects, from among multiple devices 1, a device 1 that is in a poor communication state (or to be handed over with high urgency) and is to be accessed next after the elapse of a long time period (or to be accessed by the application 61 next after the elapse of a sufficient time period). Thus, devices 1 are handed over in the order from a device in a communication environment considered to be changed, and the devices 1 may execute appropriate data collection.

The case where the communication between the devices 1 (devices or extensions) and the GWs 2 (relay devices or base units) is BLE communication is described above. However, a radio communication standard that uses FHSS and AFH is applicable to a communication system in which communication is executed according to a communication standard other than BLE. Two or more of the configurations described in the first to fourth embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of handover from a first communication device to a second communication device, the method comprising:
executing, by the first communication device, first communication with a terminal device using a first plurality of channels;
acquiring, by the second communication device, from the first communication device, connection information indicating the first communication and first channel information indicating the first plurality of channels;
specifying, by the second communication device, based on the first channel information indicating the first plurality of channels and second channel information indicating a second plurality of channels to be used by the second communication device, a third plurality of channels included in both of the first plurality of channels and the second plurality of channels;
transmitting, by the second communication device, to the first communication device, third channel information indicating the third plurality of channels;
switching, by the first communication device, the first communication with the terminal device from using the first plurality of channels to using the third plurality of channels based on the third channel information; and
executing, by the second communication device, based on the connection information acquired in the acquiring, a handover process from the first communication to a second communication which is executed between the second communication device and the terminal device using the third plurality of channels,
wherein a number of channels included in the third plurality of channels is less than one or more of a number of channels included in the first plurality of channels and a number of channels included in the second plurality of channels.

2. The method according to claim 1, wherein
the first communication device executes the first communication with the terminal device using a frequency hopping spread spectrum (FHSS) method, and
the second communication device executes the second communication with the terminal device using the FHSS method.

3. The method according to claim 2, wherein
the handover process is executed by correcting a communication timing difference of a channel included in the third plurality of channels that is useable for the first communication and the second communication.

4. The method according to claim 1, wherein
after the switching of the first communication with the terminal device from using the first plurality of channels to using the third plurality of channels, a connection destination of the terminal device is changed from the first communication device to the second communication device in the handover process.

5. The method according to claim 1, wherein
the connection information includes address information of the terminal device and an encryption key to be used to encrypt data to be transmitted by the terminal device.

6. The method according to claim 1, further comprising:
specifying, by a managing device, the first communication device as a communication destination of the terminal device in the first communication, when an intensity of a radio wave of a first signal transmitted by the terminal device and received by the first communication device is equal to or less than a first value.

7. The method according to claim 6, further comprising:
specifying, by the managing device, the second communication device as the communication destination of the terminal device in the second communication, when an intensity of a radio wave of a second signal transmitted by the terminal device and received by the second communication device is equal to or greater than a second value, and a processing load of the second communication device is equal to or less than a third value.

8. The method according to claim 6, further comprising:
specifying, by the managing device, the first communication device as the communication destination of the terminal device in the first communication, when a processing load of the first communication device is equal to or greater than a fourth value.

9. The method according to claim 6, further comprising:
specifying, by the managing device, the first communication device as the communication destination of the first communication of the terminal device, when an amount of traffic of the first communication device is equal to or greater than a fifth value.

10. The method according to claim 6, further comprising:
notifying, by the managing device, the second communication device to execute the second communication after access timing between the first communication device and the terminal device.

11. A communication system comprising:
a first communication device including a first memory and a first processor coupled to the first memory, the first processor being configured to execute first communication with a terminal device using a first plurality of channels; and
a second communication device including a second memory and a second processor coupled to the second memory, wherein
the second processor being configured to:
acquire, from the first communication device, connection information indicating the first communication and first channel information indicating the first plurality of channels,
specify, based on the first channel information indicating the first plurality of channels and second channel information indicating a second plurality of channels to be used by the second communication device, a third plurality of channels useable as the first plurality of channels and the second plurality of channels,
transmit, to the first communication device, third channel information indicating the third plurality of channels,
the first processor is configured to:
switch, the first communication with the terminal device from using the first plurality of channels to using the third plurality of channels based on the third channel information; and
the second processor is configured to:
execute, after the first processor switches the first communication with the terminal device from using the first plurality of channels to using the third plurality of channels and based on the connection information, a handover process from the first communication to a second communication which is executed between the second communication device and the terminal device using the third plurality of channels,
wherein a number of channels included in the third plurality of channels is less than one or more of a number of channels included in the first plurality of channels and a number of channels included in the second plurality of channels.

12. The communication system according to claim 11, wherein
the first communication device executes the first communication with the terminal device using a frequency hopping spread spectrum (FHSS) method, and
the second communication device executes the second communication with the terminal device using the FHSS method.

13. The communication system according to claim 12, wherein
the handover process is executed by correcting a communication timing difference of a channel included in the third plurality of channels that is useable for the first communication and the second communication.

14. A communication device comprising:
a memory; and
a processor coupled to the memory configured to:
acquire, from another communication device executing first communication with a terminal device using a first plurality of channels, connection information indicating the first communication and first channel information indicating the first plurality of channels,
specify, based on the first channel information indicating the first plurality of channels and second channel information indicating a second plurality of channels to be used by the communication device, a third plurality of channels useable as the first plurality of channels and the second plurality of channels,
transmit, to the another communication device, third channel information indicating the third plurality of channels, the another communication device switching the first communication with the terminal device from using the first plurality of channels to using the third plurality of channels based on the third channel information; and
executing, after the another communication device switches the first communication with the terminal device from using the first plurality of channels to using the third plurality of channels, based on the connection information acquired in the acquiring, a handover process from the first communication to a second communication which is executed between the communication device and the terminal device using the third plurality of channels,
wherein a number of channels included in the third plurality of channels is less than one or more of a number of channels included in the first plurality of channels and a number of channels included in the second plurality of channels.

15. The communication device according to claim 14, wherein
the another communication device executes the first communication with the terminal device using a frequency hopping spread spectrum (FHSS) method, and
the communication device executes the second communication with the terminal device using the FHSS method.

16. The communication device according to claim 15, wherein
the handover process is executed by correcting a communication timing difference of a channel included in the third plurality of channels that is useable for the first communication and the second communication.
